(19) United States
(12) Patent Application Publication
(10) Pub. No.: US 2026/0085957 A1
(43) Pub. Date: Mar. 26, 2026

(54) CLAMP-ON MECHANISM FOR ULTRASONIC FLOWMETER

(71) Applicant: TOKYO KEISO CO., LTD., TOKYO (JP)

(72) Inventors: TAKAYUKI ISHIKAWA, TOKYO (JP); TAKAHIRO KOJIMA, TOKYO (JP)

(21) Appl. No.: 19/334,977

(22) Filed: Sep. 22, 2025

(30) Foreign Application Priority Data
Sep. 20, 2024 (JP) 2024-164354

(51) Int. Cl. G01F 15/18; G01F 1/66; G01F 1/667

(52) U.S. Cl. CPC G01F 15/185; G01F 1/662; G01F 1/667

(57) ABSTRACT

A clamp-on mechanism is configured to apply an appropriate, stable pressing strength to a measurement tube, prevent plastic deformation of the measurement tube, and obtain highly accurate ultrasonic signals. The clamp-on mechanism includes a main body portion that transmits various data to the outside, and a lid portion that is coupled to the main body portion so as to be openable and closable. The main body portion includes base portions. The lid portion includes pressing pieces, which press the measurement tube on the base portions from above by the resilience of elastic bodies. When the lid portion is closed relative to the main body portion, the measurement tube, which is circular in cross section, is pressed in the up-down directions by the pressing pieces and the base portions. Thus, the measurement tube is expanded in the width direction and deformed into a substantially elliptical shape.

### FIELD OF THE DISCLOSURE

The present invention relates to a clamp-on mechanism for an ultrasonic flowmeter that fixes a fluid measuring portion to an existing measurement tube made of synthetic resin after installation.

### BACKGROUND OF THE DISCLOSURE

PTL 1 discloses a clamp-on ultrasonic flowmeter in which a piezoelectric vibrator generates guided waves by ultrasonic waves that propagate in the axial direction using, as a medium, a measurement tube through which a fluid flows.

With an ultrasonic flowmeter having a clamp-on structure that propagates such guided waves through a measurement tube, when the fluid measuring portion is fixed around an existing measurement tube, the ultrasonic transmission component needs to be in close contact with the measurement tube in order to efficiently transmit ultrasonic waves. Thus, to enhance the close contact, a soft material such as synthetic rubber or grease is sandwiched between the ultrasonic transmission component and the measurement tube.

When the fluid measuring portion is clamped onto the measurement tube, synthetic rubber or the like is inserted as a material to fill the gap between the ultrasonic transmission component and the measurement tube to improve the transmission characteristics of ultrasonic waves to the measurement tube. In this case, however, it is necessary to increase the pressing strength of the synthetic rubber against the measurement tube to transmit guided waves of sufficient magnitude to the measurement tube.

### Citation List

### Patent Literature

PTL 1: JP6106338B

### SUMMARY OF THE DISCLOSURE

However, when the pressing strength applied to the measurement tube by the fluid measuring portion from the outside is increased and the synthetic resin measurement tube is pressed with a force exceeding a force that causes plastic deformation, the measurement tube may remain in a deformed state, become less likely to return to its original shape from the deformation, have a cross-sectional area that easily changes, and further suffer from increased pressure loss, breakage, or damage.

The pressing force by the fluid measuring portion on the measurement tube is generated by a reaction force due to the deformation of each component of the clamp-on mechanism of the flowmeter at the time of clamping, but there is a problem in that the pressing force varies depending on the components and the assembling operation.

It is an objective of the present invention to provide a clamp-on mechanism for an ultrasonic flowmeter that solves the above issues, applies an appropriate, stable pressing strength to a measurement tube, prevents plastic deformation of the measurement tube made of synthetic resin, and obtains highly accurate ultrasonic signals.

According to the clamp-on mechanism for an ultrasonic flowmeter of the present invention, the fluid measuring portion can be attached with an appropriate pressing strength while preventing plastic deformation of the measurement tube. Also, an elastic structure, such as a spring, is used to apply pressure from above. This elastic structure accommodates variations in the dimensional accuracy of the product and applies a stable pressing force, thereby improving the measurement accuracy of the flowmeter and extending the life of the measurement tube.

### BRIEF DESCRIPTION OF THE DRAWINGS

FIG. 1 is a perspective view of a clamp-on mechanism attached to a measurement tube.

FIG. 2 is a perspective view of the clamp-on mechanism with the measurement tube placed on base portions and the lid portion open.

FIG. 3 is a perspective view of a main body portion.

FIG. 4 is a cross-sectional view taken along line A-A′ in FIG. 1.

FIG. 5 is a cross-sectional view taken along line B-B′ in FIG. 1.

FIG. 6 is a cross-sectional view illustrating a state in which the measurement tube is pressed by a pressing piece.

### DETAILED DESCRIPTION OF THE EXEMPLARY EMBODIMENTS

The present invention is now described in detail with reference to the illustrated embodiments.

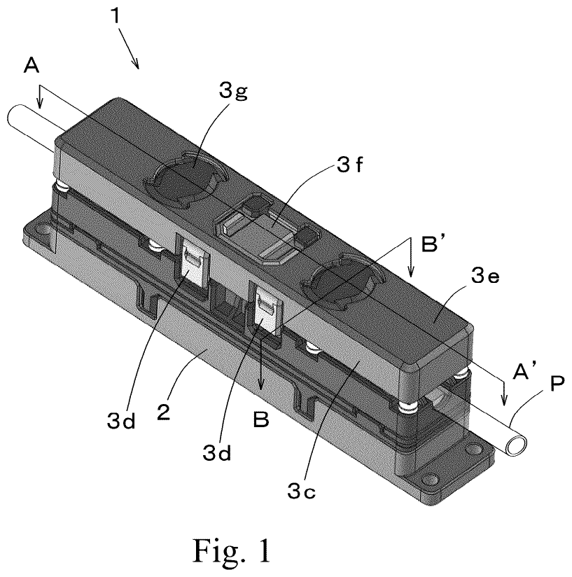

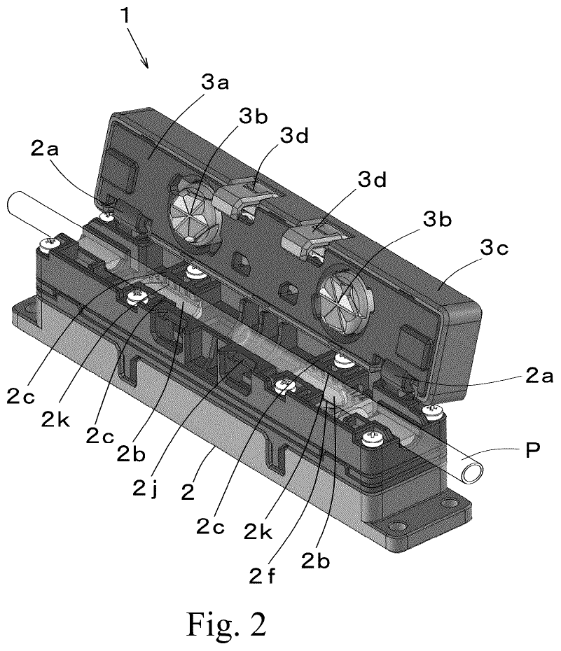

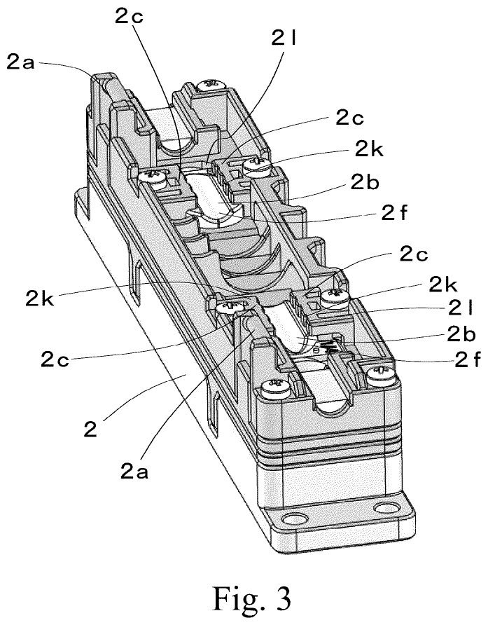

FIG. 1 is a perspective view of a clamp-on mechanism attached to a synthetic resin measurement tube, FIG. 2 is a perspective view of the clamp-on mechanism with the lid portion opened from the state illustrated in FIG. 1, and FIG. 3 is a perspective view of a main body portion.

A clamp-on mechanism 1, which is substantially a rectangular solid, includes a main body portion 2, on which a measurement tube P is placed and to which a connection cable can be connected at the bottom surface, and a lid portion 3, which is coupled to the main body portion 2 via coupling portions 2a so as to be openable and closable. The main body portion 2 includes base portions 2b, which are provided at two positions therein in the longitudinal direction, have the shape of an arcuate receiver in cross section, and on which the measurement tube P is to be placed, and side wall portions 2c, which are located on opposite sides of each base portion 2b to restrict movement of the measurement tube P in the width direction.

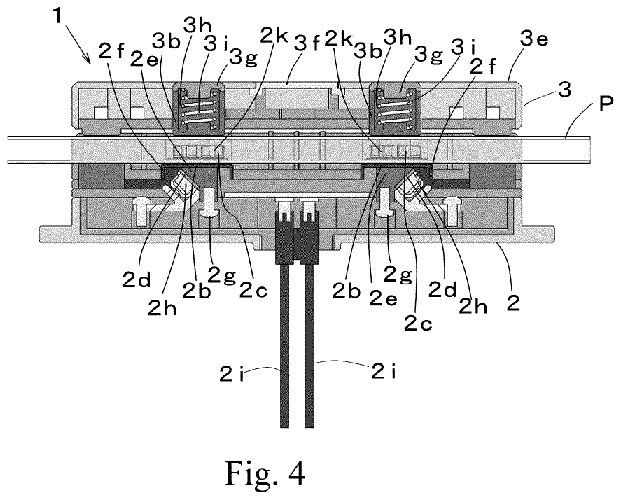

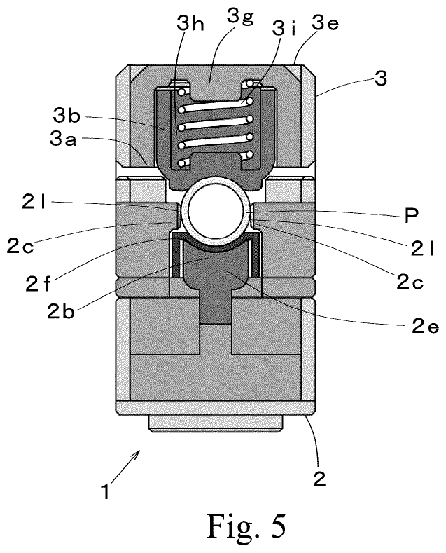

FIG. 4 is a cross-sectional view taken along line A-A′ in FIG. 1, and FIG. 5 is a cross-sectional view taken along line B-B′ in FIG. 1. The front and rear base portions 2b in the longitudinal direction are located between piezoelectric vibrators 2d, which are transmitting and receiving elements, and each include an acoustic matching layer 2e, which transmits ultrasonic waves, and a thin-film protective film portion 2f, which covers the upper side of the acoustic matching layer 2e. The acoustic matching layer 2e is fixed to the main body portion 2 from below by a fixing screw 2g, so that the base portion 2b is immobile.

The acoustic matching layer 2e made of synthetic resin or the like improves the ultrasonic wave incident/reflection characteristics with respect to the piezoelectric vibrator 2d, and the piezoelectric vibrator 2d is placed at one end of the acoustic matching layer 2e. The acoustic matching layer 2e has a shape that enables efficient transmission of ultrasonic guided waves between the piezoelectric vibrator 2d and the measurement tube P.

The protective film portion 2f, which is formed of a thin, waterproof rubber sheet material or the like, has an arc-shaped cross section conforming to the upper surface of the acoustic matching layer 2e so as to be in close contact with the lower portion of the measurement tube P as illustrated in FIG. 5.

A fluid measuring portion 2h is connected to the pair of piezoelectric vibrators 2d, which emit and receive ultrasonic waves that serve as guided waves. These piezoelectric vibrators 2d are symmetrically located facing diagonally upward and toward each other via the acoustic matching layers 2e, which are located at two positions in the longitudinal direction.

Also, the side wall portions 2c, which are located on opposite sides of the base portions 2b to serve to restrict movement of the measurement tube P in the width direction when the measurement tube P is placed on the base portions 2b, are positioned so as not to obstruct the propagation of ultrasonic waves.

As illustrated in FIG. 5, each side wall portion 2c has a contact surface 2l with the measurement tube P. The contact surface 2l is located at a position where it comes into contact with substantially the center of the measurement tube P, and is an inclined surface with an upper part projecting inward. Also, the contact surface 2l has multiple uneven portions 2k, which are arranged in the longitudinal direction and formed by grooves extending in the up-down direction.

The lid portion 3 includes pressing pieces 3b placed at the closing surface 3a of the lid portion 3. Each pressing piece 3b has a polyhedral surface, which is formed by multiple small surfaces and presses the measurement tube P with a uniform force distribution, and presses the measurement tube P on the base portions 2b from above. The lid portion 3 also includes hook-shaped locking portions 3d, which are located at the outer side surface 3c to be locked onto locked portions 2j located at the side surface of the main body portion 2 is closed, and an unlocking button 3f, which is located at the top surface 3e and unlocks the locking portions 3d when pressed.

An elastic body 3i, which is formed by a compression coil spring, is embedded in each of void portions 3h in the lid portion 3 between the pressing pieces 3b located at the closing surface 3a and elastic fixing portions 3g located at the top surface 3e. As such, due to the resilience of the elastic body 3i, the pressing piece 3b is constantly subjected to a downward pressing force. When the lid portion 3 is closed and locked with the measurement tube P placed on the base portions 2b, the pressing pieces 3b press the measurement tube P between the pressing pieces 3b and the base portions 2b with an appropriate pressing force from above.

Specifically, with a conventional structure that achieves clamping through mechanical pressing from above without using a pressing force of a spring or the like, variations in the dimensions of the components, for example, may cause variation in the pressing strength. In contrast, with the present embodiment, the pressing by the elastic bodies 3i reduces the variations in the pressing strength caused by variations of components of the pressing pieces 3b.

To attach the clamp-on mechanism 1 to the measurement tube P, the lid portion 3 is opened as illustrated in FIG. 2, the measurement tube P is placed on the front and rear base portions 2b, and the lid portion 3 is closed. When the lid portion 3 is closed, the locking portions 3d of the lid portion 3 are locked onto the locked portions 2j at the side surface of the main body portion 2, so that the lid portion 3 is brought into a locked state as illustrated in FIGS. 1, 4, and 5. This locked state will not be released unless the unlocking button 3f linked to the locking portions 3d is pressed.

In this manner, the holding portion, which includes the base portions 2b and side wall portions 2c of the main body portion 2 and the pressing pieces 3b of the lid portion 3, clamps and thus holds the measurement tube P having the shape of a straight tube. The measurement tube P held by the holding portion of the clamp-on mechanism 1 originally has a circular cross section. As illustrated in FIG. 2, when the measurement tube P is placed on the base portions 2b, the side wall portions 2c on opposite sides of the base portions 2b restrict movement of the measurement tube P in the width direction.

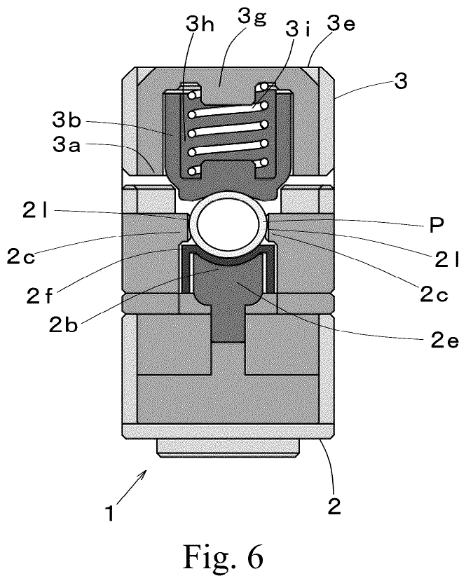

When the lid portion 3 is closed relative to the main body portion 2, the measurement tube P, which substantially has the shape of a perfect circle in cross section as illustrated in FIG. 5, is pressed from the up-down directions by the pressing pieces 3b and the base portions 2b as illustrated in FIG. 6. Thus, the measurement tube P is expanded between the side wall portions 2c in the width direction, with the size of the measurement tube P limited by the side wall portions 2c from the opposite sides. As a result, the measurement tube P is deformed into a substantially elliptical cross-sectional shape that is expanded in the width direction.

The surface of each base portion 2b, that is, the surface of each protective film portion 2f, forms an arc-shaped surface that is substantially elliptical and expanded in the width direction. Since the surfaces are thus formed, the two base portions 2b are in close contact with the lower portion of the measurement tube P, and the ultrasonic waves emitted from one of the piezoelectric vibrators 2d propagate through the measurement tube P as guided waves via the acoustic matching layers 2e and the protective film portions 2f, and are then incident on the other piezoelectric vibrator 2d.

Additionally, the contact surface 2l of each side wall portion 2c is an inclined surface inclined such that the upper part overhangs inward, that is, the upper part projects inward. The contact point of the contact surface 2l of the side wall portion 2c with the measurement tube P is slightly above the point of the measurement tube P that expands most in the width direction.

In this manner, a pair of side wall portions 2c is provided such that the measurement tube P, which is deformed by the pressing from the up-down directions, is restricted by the contact surfaces 2l from the width direction. This prevents the measurement tube P from being crushed vertically over time and increasing in flatness.

Given the measurement principle of the ultrasonic flowmeter, even when the measurement tube P is deformed, the cross-sectional area of the deformed measurement tube P needs to remain constant. It is not desirable for the cross-sectional area to change each time the lid portion 3 is opened and closed. As such, it is preferable that the change in the cross-sectional area of the measurement tube P due to the appropriate pressing force on the measurement tube P from the pressing pieces 3b be always constant.

The fluid measuring portion 2h transmits various data, such as the transmission time in the measurement tube P of the guided waves based on ultrasonic emission and reception by the pair of piezoelectric vibrators 2d, to a processing device, which is an external device, through the cable 2i.

The processing device can measure the flow rate of the fluid flowing in the measurement tube P by calculation based on the flow velocity calculated from the time difference in the transmission time of the obtained guided waves in the measurement tube P and the cross-sectional area of the measurement tube P.

The measurement processing of the flow velocity and flow rate of the fluid may be performed by a processing portion provided inside the main body portion 2 and connected to the fluid measuring portion 2h. In this case, the flow velocity, flow rate information, and the like of the fluid measured by the processing portion having a calculation function are transmitted from the processing portion to the external device via the cable 2i.

As described above, the fluid measuring portion 2h measures the flow velocity and flow rate of the fluid flowing in the measurement tube P based on the time difference in the transmission time of ultrasonic waves that propagate as guided waves through the measurement tube P as the medium. However, as long as the flow velocity and flow rate of the fluid flowing in the measurement tube P can be measured using the emission and reception of ultrasonic waves by the pair of piezoelectric vibrators 2d, any appropriate flow velocity and flow rate measurement method can be adopted.

The calculation processing by the fluid measuring portion 2h is preferably performed by an IC chip or the like built into the main body portion 2. Various data including the obtained flow rate is then transmitted to the outside via the cable 2i.

Also, each side wall portion 2c has the uneven portions 2k at the contact surface 2l to minimize the attenuation of ultrasonic waves. That is, multiple uneven portions 2k are arranged in the longitudinal direction of the measurement tube P. These multiple uneven portions 2k function to reduce the contact area and thus prevent the attenuation of ultrasonic waves.

Furthermore, the contact point of the contact surface 2l of each side wall portion 2c with the measurement tube P is positioned slightly above a point of the measurement tube P that expands most in the width direction. As a result, pressure is applied from the contact point in a direction toward the central axis of the measurement tube P, thereby generating a stronger contact force with respect to the measurement tube P placed on the base portion 2b.

In this manner, according to the clamp-on mechanism 1 for an ultrasonic flowmeter of the present invention, the fluid measuring portion 2h can be attached with an appropriate pressing strength while preventing plastic deformation of the measurement tube P. Also, an elastic structure, such as a spring, is used to apply pressure from above. This elastic structure accommodates variations in the dimensional accuracy of the product and applies a stable pressing force, thereby improving the measurement accuracy of the flowmeter and extending the life of the measurement tube.

What is claimed is:

1. A clamp-on mechanism for an ultrasonic flowmeter including a holding portion configured to hold a measurement tube having a shape of a straight tube by clamping the measurement tube, and an ultrasonic transmitting and receiving portion including a pair of piezoelectric vibrators configured to emit and receive ultrasonic waves, wherein
the holding portion includes a base portion on which the measurement tube is to be placed, a pressing piece configured to press the measurement tube on the base portion from above by an elastic force of an elastic body, and a pair of side wall portions configured to restrict movement of the measurement tube that expands in a width direction when the measurement tube is pressed from an up-down direction between the base portion and the pressing piece.

2. The clamp-on mechanism for an ultrasonic flowmeter according to claim 1, wherein the side wall portions each include multiple uneven portions arranged along a longitudinal direction of the measurement tube.

3. The clamp-on mechanism for an ultrasonic flowmeter according to claim 2, wherein the multiple uneven portions include grooves extending in the up-down direction.

4. The clamp-on mechanism for an ultrasonic flowmeter according to any one of claims 1 to 3, wherein a contact surface of each side wall portion with the measurement tube is an inclined surface inclined such that an upper part projects inward, and a contact point of the contact surface with the measurement tube is positioned slightly above a point of the measurement tube that expands most in the width direction.

5. The clamp-on mechanism for an ultrasonic flowmeter according to any one of claims 1 to 3, wherein
the clamp-on mechanism comprises a main body portion configured to be connected to an external device, and a lid portion coupled to the main body portion so as to be openable and closable, and
the main body portion includes the base portion and the pair of side wall portions, and the lid portion includes the pressing piece.

6. The clamp-on mechanism for an ultrasonic flowmeter according to any one of claims 1 to 3, wherein
the fluid measuring portion includes a pair of piezoelectric vibrators configured to emit and receive ultrasonic waves, and
the pair of piezoelectric vibrators are symmetrically located facing diagonally upward and toward each other via an acoustic matching layer located at a lower portion of the base portion.

7. The clamp-on mechanism for an ultrasonic flowmeter according to claim 6, wherein ultrasonic waves emitted from one of the piezoelectric vibrators propagate through the measurement tube as guided waves via the acoustic matching layer, and are then incident on the other of the piezoelectric vibrators.
